(19) United States
(12) Patent Application Publication
(10) Pub. No.: US 2006/0097684 A1
(43) Pub. Date: May 11, 2006

(54) Origin adjusting device of industrial robot

(75) Inventors: Seiji Iwai, Kawanishi-shi (JP); Yukinori Higashino, Kobe-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/536,594

(22) PCT Filed: Sep. 30, 2004
(86) PCT No.: PCT/JP04/14780

§ 371 Date: May 26, 2005

(30) Foreign Application Priority Data
Oct. 3, 2003 (JP) 2003-345406

(51) Int. Cl. B25J 9/10

(52) U.S. Cl. 318/568.16; 74/490.05

(57) ABSTRACT

In origin adjustment between two members which rotate relatively at a joint of an industrial robot, an origin adjustment apparatus is provided which is inexpensive and highly accurate and which requires extremely few man hours. In addition, an origin adjustment apparatus is provided which is so small in size as to be easily used even on a distal end shaft of a wrist of the robot and which requires no special signal line for origin adjustment. A mount member 23 where a positioning member 22 is embedded and a guide portion 24 along which the positioning member 22 slides in such a manner as to protrude are provided on either one or both of the two members which rotate relatively.

### TECHNICAL FIELD

The present invention relates to an industrial robot and more particularly to an origin adjusting apparatus provided at a joint portion of a robot arm.

### BACKGROUND ART

As an origin adjustment apparatus for a conventional industrial robot, there has existed, for example, a conventional origin adjustment apparatus as shown in FIG. 5. (For example, refer to JP-A-2-180580)

In FIG. 5, a first member 111 and a second member 112 are disposed coaxially and rotate relatively. A stepped portion 113 is formed on a circumferential surface of the first member 111 at an origin corresponding position, and an origin adjustment apparatus is detachably fixed to an origin corresponding position of the second member 112. This origin adjustment apparatus includes a switch holder 115 fixed to the origin corresponding position of the second member 112, a switch means 114 held by the switch holder 15 for generating an origin signal, a linear bearing 116 fixed to the switch holder 115 and a sliding rod 117 formed in such a manner as to be brought into engagement with an ON/OFF needle of the switch means 14 at one end thereof and adapted to slide by the guide of the linear bearing 116 so as to protrude towards the stepped portion 113 at the other end thereof.

In this conventional construction, since the origin adjustment apparatus is made detachable, the origin adjustment apparatus has to be mounted when performing an origin adjustment. Furthermore, a dust proof needs to be provided for a mount portion of the origin adjustment apparatus to deal with dust produced at a site where a robot is used. In addition, as a result of this, the construction becomes complex and the joint member of the robot as well as the origin adjustment apparatus become expensive.

Additionally, since a relatively large space is required to set the origin adjustment apparatus, the miniaturization of the join portion of the robot becomes difficult. In particular, at a wrist shaft of the robot which constitutes an end effector mount portion and the periphery thereof, there is caused a problem that the accessibility of a distal end portion of the wrist shaft of the robot to a workpiece (an object being or to be worked on) is disturbed.

In addition, as a second conventional example, there has existed what is to be described below (for example, refer to JP-A-2002-239967). FIG. 6 illustrates a conventional origin adjustment apparatus.

A first member 211 and a second member 212 are provided in such a manner as to rotate relatively, amount portion 223 is formed on the first member 211 for detachably mounting a positioning member 222 thereon, and an abutment surface 221, which is brought into contact with the positioning member 222, is provided on the second member 212. For example, a positioning pin is provided as the positioning member 222, and a threaded hole, into which the positioning pin can be thread fitted, is provided as the mount portion 223.

In the origin adjustment apparatus illustrated as the second conventional example, while the origin adjustment apparatus is inexpensive, since the positioning member is constructed so as to be thread fitted in the threaded hole and the fixing accuracy of the positioning member depends on to what extent the portion worked on to provide the thread and the portion worked on to provide the pin are coaxial with each other, no high positioning accuracy can be expected.

In addition, in the event that different pins, even of the same kind, are used, since the positioning accuracy deterioration is generated, no stable origin adjustment accuracy can be ensured.

### DISCLOSURE OF THE INVENTION

With a view to solving the problems inherent in the conventional examples, the invention is such that a first member and a second member which rotate relatively are provided at a joint portion of an industrial robot, a mount portion in which a positioning member is embedded and a guide portion along which the positioning member slides in such a manner as to protrude are provided on the first member, and an abutment portion which is brought into abutment with the positioning member which protrudes when the first and second members are made to rotate relatively is provided on the second member. Here, the positioning member and the guide member along which the positioning member slides adopt a socket and spigot construction which is free from mechanical loosening.

By this construction, an origin adjustment can be realized which is inexpensive and highly accurate and which requires extremely few man hours. Furthermore, since the invention requires no special signal line for origin adjustment due to the construction in which no signal generating device such as a switch is provided, despite the fact that the positioning member is incorporated in the relative rotational member, the invention also has an advantage that no cable needs to be added and modified within the robot machine. In particular, an origin adjustment which is highly accurate and which requires extremely few man hours can be realized even at the most distal end shaft of the wrist where cable layout is made difficult.

### BRIEF DESCRIPTION OF THE DRAWINGS

FIG. 1 is an explanatory drawing which shows an origin adjustment apparatus portion of an industrial robot according to a first embodiment, which is in a normal operation.

FIG. 2 is an explanatory drawing which shows the origin adjustment apparatus portion of the industrial robot according to the first embodiment, which is in an origin adjustment operation.

FIG. 3 is an explanatory drawing which shows an origin adjustment apparatus portion of an industrial robot according to a second embodiment, which is in a normal operation.

FIG. 4 is an explanatory drawing which shows the origin adjustment apparatus portion of the industrial robot according to the second embodiment, which is in an origin adjustment operation.

FIG. 5 is a drawing showing an origin adjustment apparatus of a conventional industrial robot.

FIG. 6 is a drawing showing an origin adjustment apparatus of another industrial robot.

### BEST MODE FOR CARRYING OUT THE INVENTION

Embodiments of the invention will be described below by reference to the drawings.

### First Embodiment

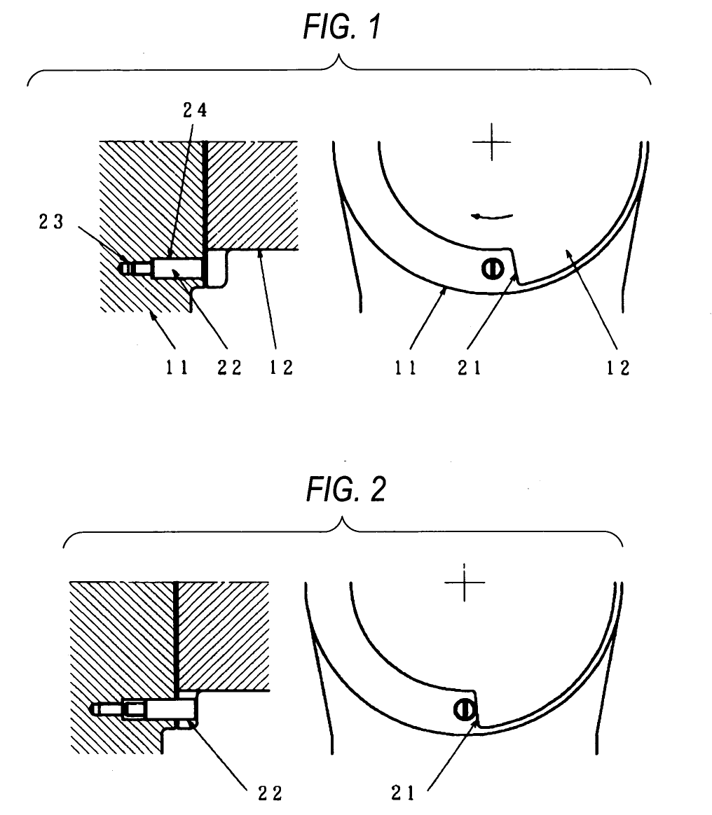

FIGS. 1, 2 are drawings showing an origin adjustment apparatus portion of an industrial robot according to a first embodiment. In the drawings, a mount portion 23 in which a positioning member 22 is embedded and a guide portion 24 along which the positioning member 22 slide in such a manner as to protrude are provided on a first member 11, and an abutment portion 21, which is brought into abutment with the positioning member 22 when the first member 11 and a second member 12 are made to rotate relatively, is provided on the second member 12.

Hereinafter, the operation of the industrial robot, which is constructed as described above, will be described. When the industrial robot performs a normal operation, as shown in FIG. 1, the first member 11 and the second member 12 are allowed to perform a free relative rotational operation, and at the same time, the positioning member 22 is embedded in the first member 11 so that a dust proof effect for the positioning member 23 and the guide portion 24 can be exhibited.

When an origin adjustment is needed, as shown in FIG. 2, the positioning member 22 is made to protrude from the first member 11 along the guide portion 24, and the positioning member 22 and the abutment portion 21 are brought into abutment with each other by relatively rotating the first member 11 and the second member 12.

Here, when determining the abutment between the positioning member 22 and the abutment portion 21, a stable determination can be implemented by monitoring a torque generated from a current to a driving motor for rotating relatively the first member 11 and the second member 12. In addition, the determination may be implemented through the sense and vision of the operator who operates the industrial robot.

Next, the positioning member 22 and the abutment member 21 are brought into abutment with each other at a mechanical origin position, and the mechanical origin is registered at this position, whereupon the origin adjustment is completed. Note that in the event that the mechanical origin position differs from the abutment position, a difference therebetween is measured in advance before an origin adjustment becomes necessary, and when performing an origin adjustment, a mechanical origin position is calculated from the abutment position and the difference now known, and the mechanical origin position so calculated is then registered as an origin position, whereby the origin adjustment is completed.

### Second Embodiment

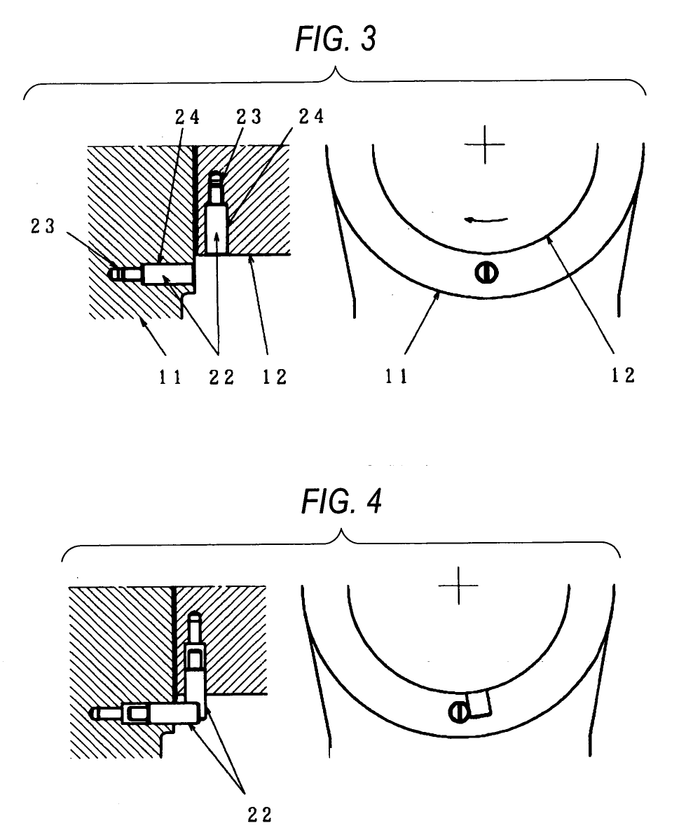

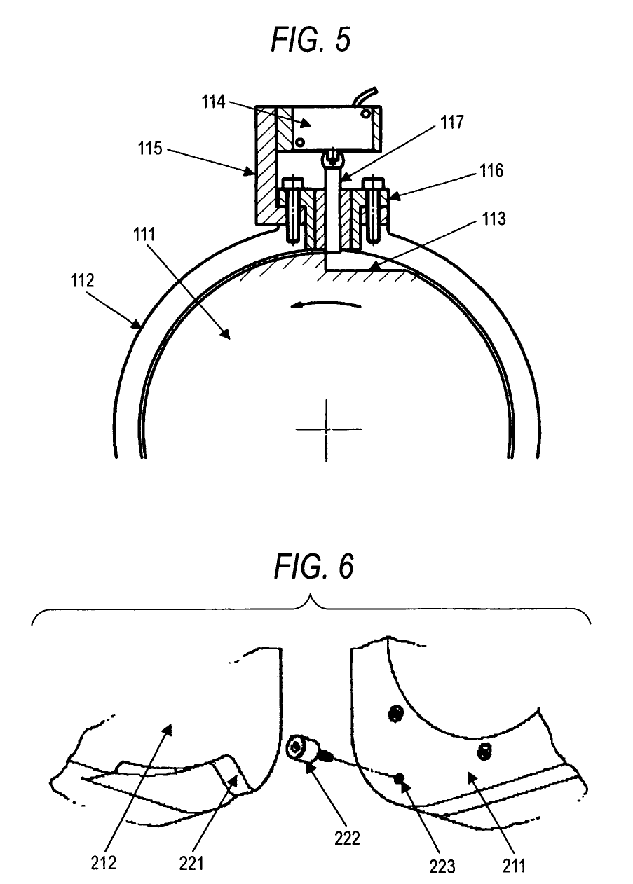

FIGS. 3, 4 are drawings showing an origin adjustment apparatus portion of an industrial robot according to a second embodiment of the invention. In FIGS. 3, 4, like reference numerals are used as to constituent members like to those described in FIGS. 1 and 2, and the description thereof will be omitted.

In this embodiment, in place of the abutment portion 21 provided on the second member 12 in the first embodiment, a positioning member 22, which was provided on the first member, and a guide portion 24 along which the positioning member 22 slides in such a manner as to protrude are provided on a second member, whereby an origin adjustment having the same function as that of the first embodiment can be realized by adopting the construction.

In the first embodiment, the abutment portion 21 is exposed to the outside, and this location needs to be protected against dust in order to perform a highly accurate origin adjustment. In this embodiment, however, the abutment portion 21 is eliminated, and as shown in FIG. 3, the positioning member 22 and the guide portion 24 are embedded when the robot performs a normal operation, and since this provides a complete dust proof construction, a stable origin adjustment can be realized over a long period of time.

### INDUSTRIAL APPLICABILITY

Since the industrial robot according to the invention is simple in construction and can perform a highly accurate origin adjustment, the robot is effective, in particular, when applied to an industrial manufacturing robot for use in production lines.

1. An industrial robot comprising a first member and a second member which rotate relatively at a joint portion thereof;
the first member including:
amount portion where a positioning member is embedded and
a guide portion along which the positioning member slides in such a manner as to protrude; and
the second member including:
an abutment portion which is brought into abutment with the positioning member when the first and second members are made to rotate relatively.

2. An industrial robot comprising a first member and a second member which rotate relatively at a joint portion thereof;
the first member including:
a first mount portion where a first positioning member is embedded and
a first guide portion along which the first positioning member slides in such a manner as to protrude; and
the second member including:
a second mount portion where a second positioning member is embedded and
a second guide portion along which the second positioning member slides in such a manner as to protrude,
whereby the first and second positioning members are brought into abutment with each other when the first member and the second member are made to rotate relatively.

3. An industrial robot as set forth in claim 1 or 2, wherein the positioning member is held at a position where the positioning member does not protrude from the first member when performing a normal operation, whereas only when performing an origin adjustment, the positioning member is made to protrude.

4. An industrial robot as set forth in claim 3, wherein the positioning member is brought into abutment at a mechanical origin position of the industrial robot.

5. An industrial robot as set forth in claim 3, further comprising calculation means for bringing the positioning member into abutment at a position which is displaced from a mechanical origin position through a known angle determined in advance and calculating the mechanical origin position using the known angular displacement and the abutment position of the positioning member.

6. An industrial robot as set forth in claim 3, wherein the abutment of the positioning member is determined by monitoring a torque generated in the second member using a current to a driving motor for relatively rotating the second member.
